(19) United States
(12) Patent Application Publication
(10) Pub. No.: US 2018/0304204 A1
(43) Pub. Date: Oct. 25, 2018

(54) SYSTEM FOR OPERATING A CERAMIC MEMBRANE AND RELATED METHODS

(71) Applicant: NANOSTONE WATER INC., Eden Prairie, MN (US)

(72) Inventors: Stanton SMITH, Eden Prairie, MN (US); Brian WISE, Eden Prairie, MN (US); Aditya KUMAR, Eden Prairie, MN (US); Christopher J. KURTH, Eden Prairie, MN (US)

(73) Assignee: Nanostone Water Inc., Eden Prairie, MN (US)

(21) Appl. No.: 15/738,046

(22) PCT Filed: Jun. 17, 2016
(86) PCT No.: PCT/US2016/038204

§ 371 Date: Dec. 19, 2017

Related U.S. Application Data
(60) Provisional application No. 62/182,244, filed on Jun. 19, 2015.

(51) Int. Cl. B01D 65/02; C02F 1/44

(52) U.S. Cl. CPC B01D 65/02; C02F 1/444; B01D 2313/18; B01D 2313/24; B01D 2315/08; C02F 2303/16; B01D 2321/12; C02F 2209/03; C02F 2209/40; C02F 2209/44; B01D 2321/04

(57) ABSTRACT

A method includes supplying feed water in a forward direction into a ceramic membrane treatment system at a first rate the ceramic membrane treatment system including at least one ceramic membrane (120), and determining production cycle data of the system, the production cycle data including one of more of accumulation data, feed pressure data, and time since last backflush. The method further includes determining optimal physical flux parameters based on the production cycle data and efficiency of a previous flux maintenance event, conducting a flux maintenance event including accelerated cleaning of the at least one ceramic membrane at a second rate by using a square step backwash rate based on optimal physical flux parameters. The squre step rate can be generated by ramping up pressure by a pump (220) against a closed valve (222) and a sudden openin of said valve.

### PRIORITY CLAIM

This application claims priority to U.S. Provisional Application No. 62/182,244 that was filed on 19 Jun. 2015. The entire content of this provisional application is hereby incorporated herein by reference.

### TECHNICAL FIELD

A system for operating a ceramic membrane and related methods.

### TECHNICAL BACKGROUND

Ceramic membranes are known to have benefits relative to polymerics with respect to lifetime, stability to high temperatures, ability to operate at high pressures, and resistance to a wide range of chemicals. However, they have required complex and expensive system to be used effectively. In particular, these systems have either used high pressure back pulses, preferably with a system designed to hit the membrane with a pressure wave over a very short period of time at above several bars, or else large amounts of recirculation to continuously sweep retained materials off the membrane surface. These have resulted in undue cost and complexity in the design of systems taking advantage of ceramic membranes.

Polymeric hollow fiber systems are typically designed without these design features, but very low productivities (polymer membranes typically produce 50-100 liters of water per square meter per hour). As polymeric membranes are more susceptible to fouling and breakage, they have a shorter lifetime and require frequent replacement (typically every 3-10 years). Although ceramic membranes are known to last much longer (15-25 years), the lack of backpulse and/or cross flow systems precludes systems designed for use with polymeric membranes to be retrofitted with ceramics to take advantage of their numerous benefits.

Polymeric and ceramic membranes have been used to remove a wide range of contaminants from various waters. Polymeric systems are typically made with a number of hollow fibers potted together in a housing containing 20-100 m² of membrane area. These are typically run with very little recirculation, and more commonly with no recirculation for a period of time, followed by a cleaning backflush where the water flow is reversed at a flow from 0.2 to 2 times the flow of the forward flow step. In some cases air is injected into the base of the membrane and allowed to rise next to the membrane to further remove contaminants by air scour.

Ceramic membranes typically have less active area per module, typically up to 25 m² at the highest. These ceramic membranes typically comprise a ceramic mass with a number of feed channels running down the membrane length. Such ceramic membranes are sometimes referred to as honeycomb designs due to the hexagonal arrangement of channels. The channels are coated with a separating layer and the feed water flows into these channels, with the treated water exiting the outside of the module. Enabled by the low fouling surface of ceramic membranes, the membranes are run more aggressively than polymerics, typically 100 to 500 liters per square meter per hour, and as such, produce a similar amount of water per module. This higher flux leads to a more rapid deposition of foulants on the membrane surface in comparison to a polymeric membrane. Since higher backwash pressures are more effective at removing foulants and with stability of ceramic membranes to pressure, this retained material can be effectively removed with a high pressure backpulse (3-5 bar common) which lifts the material off the surface, and a purge step where water is flushed through the feed side to sweep material into a discharge system. Ceramic systems run in this type of dead end or low crossflow mode of operation typically have a backpulse frequency of typically every 1 to 2 hours. This long duration is required to maintain a high system recovery with the increased water used per backpulse. This mode of operation leads to some significant changes to ceramic system design (for example WO2015/053622 and U.S. Pat. No. 8,083,943). As a large amount of water is flushed through the system during this step (flow rates during a backpulse are typically 5-10 times that of the flow rate in forward flow), a fairly large pipe diameter needs to be used on both the permeate and discharge sides to minimize pressure losses in the piping and even then smaller number of membranes can be assembled into a membrane rack, resulting in numerous, smaller membrane racks versus polymeric membrane systems. A backpulse tank is typically used to provide backpulse water at elevated pressure, and the entire system and piping is designed to carefully avoid the presence of entrained air in the permeate side which would slow the pressure build up due to the presence of compressible gasses.

Alternatively, some ceramic membranes have used a relatively large recirculation rate to sweep materials off membrane surface and prolong the operating period between exposures to reverse flow to clean the membrane further. This requires larger piping to the membrane modules, and a larger pump to handle the increase flow rate feeding each module. In general, the result is a more complex system offering for the typical ceramic membrane offering.

### SUMMARY

In one or more embodiments, a method includes providing feed water in a forward direction into a ceramic membrane treatment system at a first rate, the ceramic membrane treatment system including at least one ceramic membrane, and determining production cycle data of the system, the production cycle data including one of more of accumulation data, feed pressure data, and time since last backflush. The method further includes determining optimal physical flux parameters based on the production cycle data and efficiency of a previous flux maintenance event, conducting a flux maintenance event including accelerated cleaning of the at least one ceramic membrane, conducting the flux maintenance event including backwashing the ceramic membrane at a second rate, where the second rate is typically 0.5-3 times the first rate, conducting the flux maintenance event based on optimal physical flux parameters.

In one or more embodiments, the ceramic membrane treatment system includes a pump fluidly coupled with at least one valve, and accelerated cleaning of the at least one ceramic membrane includes ramping up the pump prior to opening the valve to build pressure within the ceramic membrane treatment system.

In one or more embodiments, accelerated cleaning includes initiating a motive force in backwash and prepare the motive force for quick flow delivery by closing an outlet block valve, maintaining a motive backwash force until the supplying feed water stops flowing.

In one or more embodiments, the method further includes releasing the outlet block valve to allow rapid rise of the second flow rate after the feed supply stops, and optionally continuing the back flushing past the outlet block valve for a predetermined period of time.

In one or more embodiments, initiating motive force for backwash includes closing the backwash pump outlet block valve and ramping a backwash pump against the valve, and optionally ramping up includes ramping up to a predetermined pressure within the treatment system.

In one or more embodiments, initiating the motive force for backwash includes closing the backwash pressure outlet block valve and increasing a backwash tank driving gas pressure up against the outlet block valve.

In one or more embodiments, the method further includes adding 0.5-5 ppm of a coagulant to the feed water prior to the at least one ceramic membrane.

In one or more embodiments, feeding feed water into the ceramic membrane module occurs exclusively in dead end mode.

In one or more embodiments, feeding feed water into the ceramic membrane module occurs exclusively in a low crossflow-feed mode.

In one or more embodiments, the method further includes tracking module recovery after conducting the flux maintenance event, and using this data to determine next flux maintenance parameters.

In one or more embodiments, accelerated cleaning of the at least one ceramic membrane includes a square step backwash rate increase.

In one or more embodiments, a ceramic membrane treatment system includes at least one ceramic membrane module including one or more ceramic membranes, the membrane module having at least one feed water input.

The treatment system further includes a feed water system including at least one feed water storage, feed water line, and feed water pump. The feed water line is fluidly coupled between the at least one feed water storage and the feed water input of the ceramic membrane module. The feed water pump is coupled with the feed water line between the at least one ceramic membrane module and the feed water storage.

The treatment system further includes a permeate system including a permeate line and permeate storage. The permeate line is coupled between the at least one ceramic membrane module and the permeate storage. The permeate system includes a second permeate line coupled with a permeate pump to pump permeate downstream.

The treatment system still further includes at least one backwash system including a backwash line and a backwash pump. The backwash line is coupled between the permeate line and the permeate storage, where the backwash line having an outlet block valve.

The treatment system has an accelerated cleaning mode in which the backwash pump is initiated until forward flow from the feed water storage ceases and pressure within the backwash line is raised against the outlet block valve, and the outlet block valve is released to achieve a square step cleaning function of the at least one membrane.

The treatment system also has a data collection mode in which data regarding accumulation data, feed pressure, and time between previous back flushes are collected.

The treatment system still further has a data evaluation and maintenance determination mode in which data from the data collection mode is evaluated and an optimal maintenance parameters are determined from the data collection and data evaluation.

In one or more embodiments, in the accelerated cleaning mode, a backwash tank driving gas pressure is raised up against the valve to a selected set point. In one or more embodiments, in the accelerated cleaning mode, a backwash pump is ramped up against the outlet block valve to a selected set point.

These and other embodiments, aspects, advantages, and features of the present invention will be set forth in part in the description which follows, and will become apparent to those skilled in the art by reference to the following description of the invention and referenced drawings or by practice of the invention. The aspects, advantages, and features of the invention are realized and attained by means of the instrumentalities, procedures, and combinations particularly pointed out in the appended claims and their equivalents.

### BRIEF DESCRIPTION OF THE FIGURES

FIG. 1 is a block diagram of a portion of a system according to one or more embodiments.

FIGS. 2-4 illustrate data of the system in use according to one or more embodiments.

FIG. 5 illustrates a table on deposition amount with flux, time between backflush/pulse, and solids loading.

FIG. 6 illustrates a chart of the backwash flow rate using the square step backwash method, according to one or more embodiments.

### DETAILED DESCRIPTION

The following detailed description includes references to the accompanying drawings, which form a part of the detailed description. The drawings show, by way of illustration, specific embodiments in which the apparatus may be practiced. These embodiments, which are also referred to herein as “examples” or “options,” are described in enough detail to enable those skilled in the art to practice the present embodiments. The embodiments may be combined, other embodiments may be utilized or structural or logical changes may be made without departing from the scope of the invention. The following detailed description is, therefore, not to be taken in a limiting sense and the scope of the invention is defined by the appended claims and their legal equivalents.

In this document, the terms “a” or “an” are used to include one or more than one, and the term “or” is used to refer to a nonexclusive “or” unless otherwise indicated. In addition, it is to be understood that the phraseology or terminology employed herein, and not otherwise defined, is for the purpose of description only and not of limitation.

In this document, the terms backflush and backwash are used interchangeably to describe flow of purified water in a reverse direction relative to the flow of water during purification at a low rate(0.5 to 3× forward flow), with the driving pressure arising from a pump. The term backpulse is used to describe flow of purified water in a reverse direction relative to the flow of water during purification at a high rate (5 to 10× forward flow), with the driving pressure arising from a pressurized reservoir.

A system and method is described herein which includes high frequency backwash performed, and before a large amount of material has accumulated on the membrane surface.

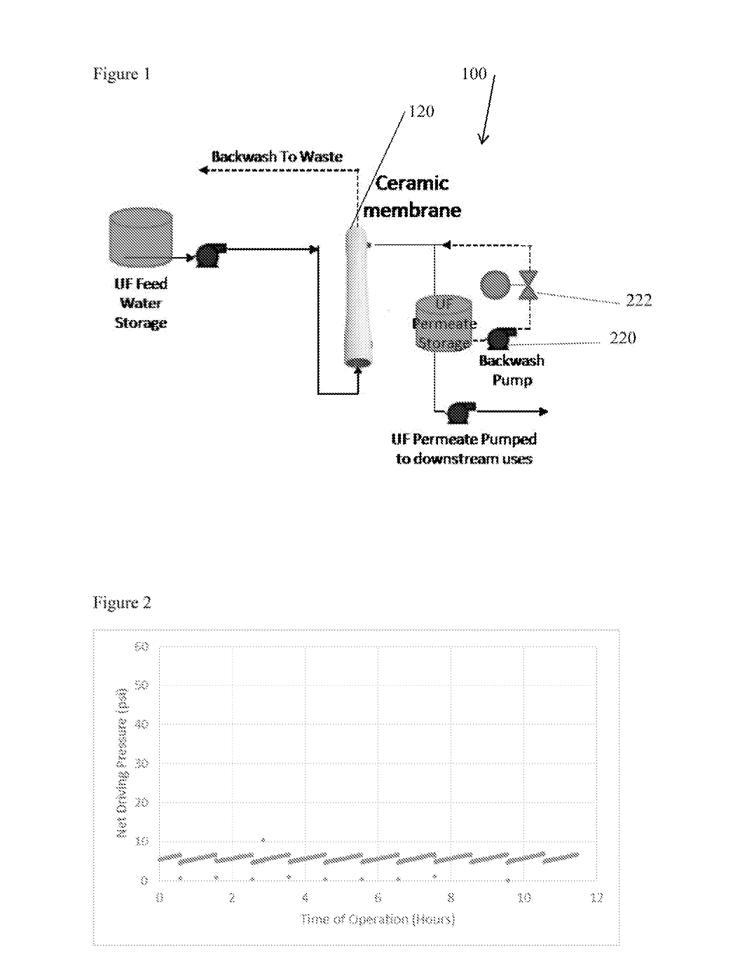

FIG. 1 illustrates a system which includes a system 100 includes an input of feedwater in a first direction to a ceramic membrane 120. The system 100 further includes UF permeate storage which has an output to backwash the ceramic membrane 120 via a backwash pump. The permeate storage also has an output for ultra-filtration (UF) filtrate for reuse or further treatment. In one or embodiments, the ceramic membrane is used in dead end mode where the feed flow rate equals the permeate flow rate. In one or more embodiments, the ceramic membrane is used in low crossflow mode with a small amount of crossflow may be used and the feed flow rate may be up to twice the permeate flow rate.

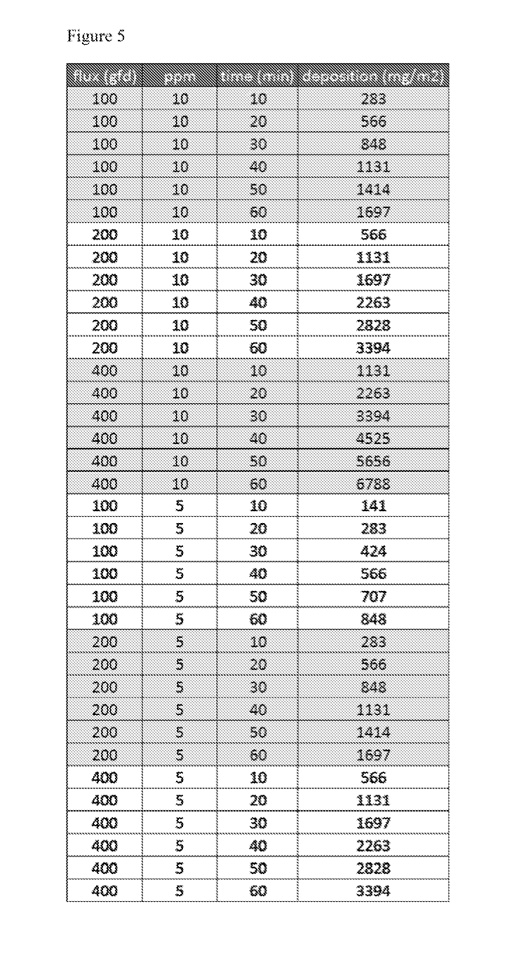

In one or more embodiments, a low flow backflush is performed on the ceramic membrane to clean the membrane. In one or more embodiments, the low flow backflush is performed at a rate of 0.5 to 3 times the flow of the forward flush. In one or more embodiments, the low flow backflush is performed at a frequency of once approximately every about 5-60 minutes or more preferably approximately once every 10-30 minutes. In one or more embodiments, the backwashing occurs prior to less than 1700 mg/m² of material accumulated on a surface of the at least one ceramic membrane, or prior to 1000-1700 mg/m² of material has accumulated on the surface, or even more preferably prior to 600 mg/m² of material has accumulated on the surface. FIG. 5 illustrates additional options. In one or more embodiments, the backwashing occurs prior to the feed pressure rising by 30% of its pressure at the beginning of a forward flow cycle.

The low flow backflush at high frequency is able to remove the contaminants from a ceramic membrane as effectively as a backpulse. In a preferred method of operating, 50-95% of the material deposited on the surface is removed with each backflush (removal efficiency), even more preferred is 75-97.5% removal. With this removal efficiency and the relatively low backflush rates the concentration of the discharge stream relative to that in the feed stream (concentration factor) is 30 to 75, and even more preferred to be 45-85. Note that concentrations of solids measured in the discharge may be differ from these concentrations factors due to volume changes resulting from the forward feed flush.

The flow distribution of a backflush is improved in ceramic membranes having a low amount of foulant deposition. Longer periods between backwashes have the benefit of increase the amount of water the system can produce, but this is balanced by the effectiveness which improves at shorter durations. Optimizing this time between backwashes based on a specific water source is useful for most efficient system operation.

The duration of the backflush can be varied, and minimized so that high system recoveries can still be maintained even with the high frequency of backwash operations by using a short duration for the backwash. Preferably the duration of the backwash is less than 30 seconds, even more preferably it is less than 15 seconds. After the low flow backwash, some feed water is fed through the channels to sweep contaminants into the system outlet. In order to use the same pump as is used to forward flow operation, it is preferable if this flow rate is no more than 3× the forward flow rate. Even more preferably this sweep flow is no more than 2 times the forward flow rate. In one or embodiments, the ceramic membrane is used in dead end mode. Dead end flow is a method in which while treated water is being produced through the membrane, the feed flow rate is about equal to the treated water flow rate.

In one or more embodiments, the ceramic membrane is used in dead end mode with a small amount of crossflow feed mode may be used. Cross flow operation is a method in which the feed flow rate is higher than the treated water flow rate, and extra feed flow exits the module after passing through the feed channels in the ceramic membrane. In one or more embodiments, a small amount of crossflow is one in which less than 5 psid of crossflow-related pressure loss is observed from the entrance to exit of the module. In another embodiment the crossflow is limited to less than twice the permeate flow rate.

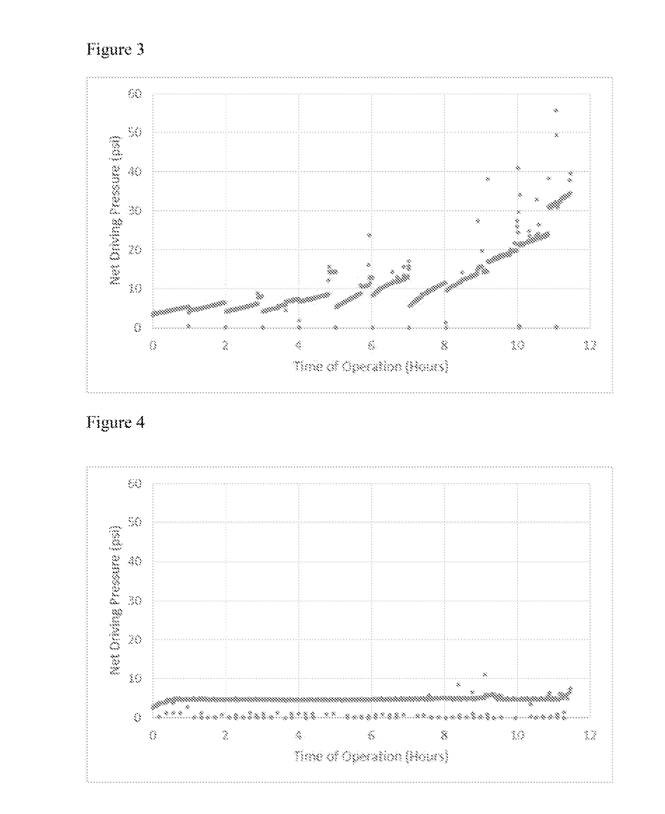

FIGS. 2-4 illustrate performance data of the system incorporating the methods described herein. FIG. 2 shows operation typical of a ceramic system incorporating a backpulse. The feed water source is river water, and 1 ppm of polyaluminum chloride is added to the feed immediately prior to the membrane. Every 60 minutes filtered water is allowed to flow through the membrane in a reverse direction from a pressure reservoir maintained at 5 bar with air pressure. During each cycle the net driving pressure increases, and is then restored by the backpulse leading to stable operation over the time period shown. This illustrates the way ceramic membranes have been operated in a dead end mode.

FIG. 3 shows operation of a ceramic system using a backwash at a frequency typical for a ceramic, 60 minutes. The feed water source is river water, and 1 ppm of polyaluminum chloride is added to the feed immediately prior to the membrane. Every 60 minutes filtered water is allowed to flow through the membrane in a reverse direction using a pump operating at 2× the flow rate used in forward operation. During each cycle the net driving pressure increase, and is then reduced slightly by the backwash. However due to its reduced efficacy nonstable operation is observed with each cycle operating at increasing pressures. This illustrates the reason backpulse has been used, at the typical processing times for ceramics, a low flow backwash is unable to sufficiently restore performance.

FIG. 4 shows operation of a ceramic system using the high frequency backwash of this invention, 20 minutes in this case. The feed water source is river water, and 1 ppm of polyaluminum chloride is added to the feed immediately prior to the membrane. Every 20 minutes filtered water is allowed to flow through the membrane in a reverse direction using a pump operating at 2× the flow rate used in forward operation. In this example less materials is deposited during each cycle as seen in the relatively small pressure increase over 20 minute cycles. Surprisingly, the backwash effectiveness is high at this shorter cycle time and as a result stable operation was observed over the time period shown.

FIG. 5 illustrates variations on operations including deposition amount with flux, time between backflush/pulse, and solids loading.

In one or more embodiments, a method includes supplying feed water into a ceramic membrane treatment system at a first rate, the ceramic membrane treatment system including at least one ceramic membrane, and determining production cycle data of the system, the production cycle data including one of more of accumulation data, feed pressure data, and time since last backflush. The method further includes determining optimal physical flux parameters based on the production cycle data and efficiency of a previous flux maintenance event.

The following is an example of how optimal physical flux parameters are determined. A clean membrane has clean water permeability (CWP) of 100% and the very first production cycle showed and initial permeability of 80% (of the CWP) and this is logged as the membrane clean production permeability (CPP). The backwash pump pressure for this first production cycle is determined as backwash flux/CPP plus line losses, and the pump speed is determined from the pump curve at the known flow (from known backwash flux setpoint) and the calculated backwash pressure. After a long operation period, a production cycle had an initial permeability of 60% (of the CWP) and the backwash pump pressure is determined as backwash flux/0.6*CWP plus line losses and the backwash pump speed is again determined as before, and the pump speed setpoint entered into the backwash pump drive. The actual flow rate of the backwash from a prior backwash cycle as well as the performance recovery may also be measured and used to refine the speed for the next backwash cycle. In one or more embodiments, a positive displacement backwash pump is used to set a fixed backwash flow regardless of pressure/fouling rate.

The method further includes conducting a flux maintenance event including accelerated cleaning of the at least one ceramic membrane, conducting the flux maintenance event including backwashing the ceramic membrane at a second rate, where the second rate is 0.5-3 times the first rate, conducting the flux maintenance event based on optimal physical flux parameters.

In one or more embodiments, the ceramic membrane treatment system includes a pump fluidly coupled with at least one valve, and accelerated cleaning of the at least one ceramic membrane includes ramping up the pump prior to opening the valve to build pressure within the ceramic membrane treatment system.

In one or more embodiments, accelerated cleaning includes initiating a motive force in backwash and prepare the motive force for quick flow delivery by closing an outlet block valve, maintaining a motive backwash force until the first flow stops flowing.

In one or more embodiments, the method further includes releasing the outlet block valve to allow rapid rise of the second flow rate after the first flow stops, and optionally continuing the second flow past the outlet block valve for a predetermined period of time.

In one or more embodiments, initiating motive force for backwash includes closing the backwash pump outlet block valve and ramping a backwash pump against the valve, and optionally ramping up includes ramping up to a predetermined pressure within the treatment system.

In one or more embodiments, initiating the motive force for backwash includes closing the backwash pressure outlet block valve and increasing a backwash tank driving gas pressure up against the outlet block valve.

In one or more embodiments, the method further includes adding 0.5-5 ppm of a coagulant to the feed water prior to the at least one ceramic membrane.

In one or more embodiments, feeding feed water into the ceramic membrane module occurs exclusively in dead end mode.

In one or more embodiments, feeding feed water into the ceramic membrane module occurs exclusively in a low crossflow-feed mode.

In one or more embodiments, the method further includes tracking module recovery after conducting the flux maintenance event, and using this data to determine next flux maintenance parameters.

In one or more embodiments, accelerated cleaning of the at least one ceramic membrane includes square step backwash rate increase.

In one or more embodiments, a ceramic membrane treatment system includes at least one ceramic membrane module including one or more ceramic membranes, the membrane module having at least one feed water input.

The treatment system further includes a feed water system including at least one feed water storage, feed water line, and feed water pump. The feed water line is fluidly coupled between the at least one feed water storage and the feed water input of the ceramic membrane module. The feed water pump is coupled with the feed water line between the at least one ceramic membrane module and the feed water storage.

The treatment system further includes a permeate system including a permeate line and permeate storage. The permeate line is coupled between the at least one ceramic membrane module and the permeate storage. The permeate system includes a second permeate line coupled with a permeate pump to pump permeate downstream.

The treatment system still further includes at least one backwash system including a backwash line and a backwash pump. The backwash line is coupled between the permeate line and the permeate storage, where the backwash line having an outlet block valve.

The treatment system has an accelerated cleaning mode in which the backwash pump is initiated until forward flow from the feed water storage ceases and pressure within the backwash line is raised against the outlet block valve, and the outlet block valve is released to achieve a square step cleaning function of the at least one membrane.

The treatment system also has a data collection mode in which data regarding accumulation data, feed pressure, and time between previous back flushes are collected.

The treatment system still further has a data evaluation and maintenance determination mode in which data from the data collection mode is evaluated and an optimal maintenance parameters are determined from the data collection and data evaluation. In one or more embodiments, a programmable logic controller (PLC) is used for the maintenance determine mode to do the evaluation. In order to implement the optimized parameters, a speed controller is used for a backwash pump, and/or an air pressure controller is used on an air backwash system, and similar controls for other driving force mechanisms.

In one or more embodiments, in the accelerated cleaning mode, a backwash tank driving gas pressure is raised up against the valve to a selected set point. In one or more embodiments, in the accelerated cleaning mode, a backwash pump is ramped up against the outlet block valve to a selected set point.

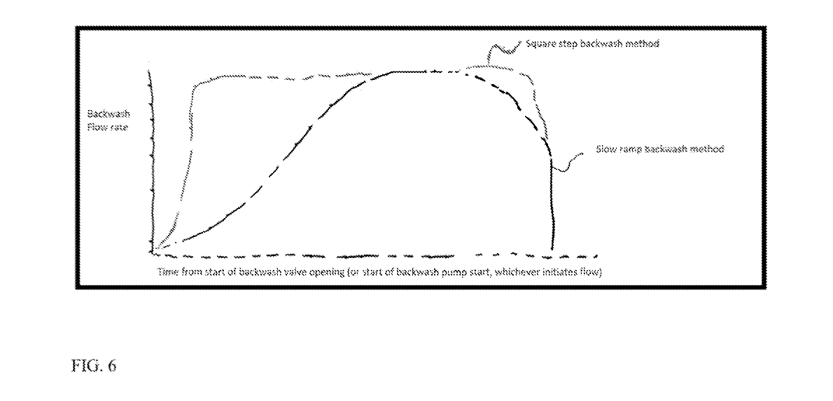

What is meant by square step backwash rate increase, as shown in FIGS. 2 and 6, is an efficient physical flux maintenance event. The square step backwash is applied irrespective of backwash rate or pressure, backwash type and introduces a high energy near-instantaneous full rate delivery approach of the backwash flow to the membrane rather than slowly ramping up the flow through the membrane. The square step backwash rate does not intend to set a higher peak backwash rate, but delivers the peak flow rate as quickly as possible to the membrane and sustain the peak flow rate throughout backwash time, thereby maximizing the portion of the backwash time during which the membrane is exposed to the beak backwash flow, but starting with the peak flow rate, rather than a slow ramp rate, as illustrated in FIGS. 2 and 6.

The square step back wash is conducted, in one or more embodiments, as follows. During the last part of the production run, the motive force for back wash is initiated. In one or more embodiments, this is done by closing the backwash pump outlet block valve 222 of the backwash pump 220, and ramping the backwash pump 220 up against the valve 222 to a selected setpoint as developed during the physical flux maintenance preparation step.

In one or more embodiments, the motive force for backwash is initiated by closing a backwash pressure vessel outlet block valve 222, and ramping the backwash tank 250 driving gas pressure up against the valve 222 to the selected set point as developed during the physical flux maintenance preparation step. In one or more embodiments, this can be repeated for other driving force mechanisms, such as, but not limited to pumps, air, or hydraulic pistons.

In one or more embodiments, the method further including holding the backwash driving force at the set point until production, or forward flow, ceases. The production stops, or the forward flow stops, the backwash block valve is rapidly opened to release the flow rapidly to enable a rapid rise of the flow rate from zero to the peak flow rate in a square step function.

The method further allows for flow in a backflush direction until a set time as selected during the preparation step, and then close the block valve to stop the backwash flow. If necessary, any of the feed flush or physical flux maintenance events can also occur.

The production is resumed and forward flow resumes, for example, at a first rate.

The preparation step for the maintenance, or cleaning, includes collecting data of production pre and post maintenance, and then evaluating the data.

Polymeric systems are much more common than ceramic systems, so system manufacturers are often unfamiliar with the significantly altered designs ceramic membranes have required. The embodiments described herein allow manufacturers to use more common components to produce systems more economically.

Further, since the operating flows and pressures match those used with polymer membranes, existing systems including pumps, piping, and controls can now be used to run a ceramic membrane while offering the benefits of longer life, and improved stability. The system and method allows for the ability to retrofit polymeric systems with ceramic membranes and to build system with high quality commodity components.

It is to be understood that the above description is intended to be illustrative, and not restrictive. Many other embodiments will be apparent to those of skill in the art upon reading and understanding the above description. It should be noted that embodiments discussed in different portions of the description or referred to in different drawings can be combined to form additional embodiments of the present application. The scope should, therefore, be determined with reference to the appended claims, along with the full scope of equivalents to which such claims are entitled.

1. A method comprising:
supplying feed water feed water into a ceramic membrane treatment system at a first rate, the ceramic membrane treatment system including at least one ceramic membrane;
determining production cycle data of the system, the production cycle data including one of more of accumulation data, feed pressure data, and time since last backflush;
determining optimal physical flux parameters based on the production cycle data and efficiency of a previous flux maintenance event; and
conducting a flux maintenance event including accelerated cleaning of the at least one ceramic membrane, conducting the flux maintenance event including backwashing the ceramic membrane at a second rate, where the second rate is 0.5-3 times the first rate, conducting the flux maintenance event based on optimal physical flux parameters.

2. The method as recited in claim 1, wherein the ceramic membrane treatment system includes a pump fluidly coupled with at least one valve, and accelerated cleaning of the at least one ceramic membrane includes ramping up the pump prior to opening the valve to build pressure within the ceramic membrane treatment system.

3. The method as recited in claim 1, wherein accelerated cleaning includes initiating a motive force in backwash and preparing the motive force for quick flow delivery by closing an outlet block valve, maintaining a motive backwash force until the forward flow stops flowing.

4. The method as recited in claim 3, further comprising releasing the outlet block valve to allow rapid rise of the second flow rate after the forward flow stops.

5. The method as recited in claim 4, further comprising continuing the second flow past the outlet block valve for a predetermined period of time.

6. The method as recited in claim 3, wherein initiating motive force for backwash includes closing the backwash pump outlet block valve and ramping a backwash pump against the valve.

7. The method as recited in claim 6, wherein ramping up includes ramping up to a predetermined pressure within the treatment system.

8. The method as recited in claim 3, wherein initiating the motive force for backwash includes closing the backwash pressure outlet block valve and increasing a backwash tank driving gas pressure up against the outlet block valve.

9. The method as recited in any one of claims 1-8, further comprising adding 0.5-5 ppm of a coagulant to the feed water prior to the at least one ceramic membrane.

10. The method as recited in any one of claims 1-9, wherein supplying feed water feed water into the ceramic membrane module occurs in dead end mode.

11. The method as recited in any one of claims 1-10, wherein supplying feed water feed water into the ceramic membrane module occurs exclusively in a low crossflow-feed mode.

12. The method as recited in any one of claims 1-11, further comprising tracking module recovery after conducting the flux maintenance event, and using this data to determine next flux maintenance parameters.

13. The method as recited in any one of claims 1-12, wherein accelerated cleaning of the at least one ceramic membrane includes a square step backwash rate increase.

14. A ceramic membrane treatment system comprising:
at least one ceramic membrane module including one or more ceramic membranes, the membrane module having at least one feed water input;
a feed water system including at least one feed water storage, feed water line, and feed water pump, the feed water line fluidly coupled between the at least one feed water storage and the feed water input of the ceramic membrane module, the feed water pump coupled with the feed water line between the at least one ceramic membrane module and the feed water storage;
a permeate system including a permeate line and permeate storage, the permeate line coupled between the at least one ceramic membrane module and the permeate storage, the permeate system including a second permeate line coupled with a permeate pump to pump permeate downstream;
at least one backwash system including a backwash line and a backwash pump, the backwash line coupled between the permeate line and the permeate storage, the backwash line having an outlet block valve;
the system having an accelerated cleaning mode in which the backwash pump is initiated until forward flow from the feed water storage ceases and pressure within the backwash line is raised against the outlet block valve, and the outlet block valve is released to achieve a square step cleaning function of the at least one membrane;
the system having data collection mode in which data regarding accumulation data, feed pressure, and time between previous back flushes are collected; and
the system having a data evaluation and maintenance determination mode in which data from the data collection mode is evaluated and an optimal maintenance parameters are determined from the data collection and data evaluation.

15. The ceramic membrane treatment system as recited in claim 14, wherein in the accelerated cleaning mode, a backwash tank driving gas pressure is raised up against the valve to a selected set point.

16. The ceramic membrane treatment system as recited in claim 14, wherein in the accelerated cleaning mode, a backwash pump is ramped up against the outlet block valve to a selected set point.
